(19) United States
(12) Patent Application Publication
(10) Pub. No.: US 2025/0077379 A1
(43) Pub. Date: Mar. 6, 2025

(54) PERFORMANCE AND MEMORY ACCESS TRACKING AND VISUALIZATION

(71) Applicants: Advanced Micro Devices, Inc., Santa Clara, CA (US); ATI Technologies ULC, Markham (CA)

(72) Inventors: Guennadi Riguer, Markham (CA); Christopher J. Brennan, Boxborough, MA (US)

(73) Assignees: Advanced Micro Devices, Inc., Santa Clara, CA (US); ATI Technologies ULC, Markham (CA)

(21) Appl. No.: 18/460,678

(22) Filed: Sep. 4, 2023

(51) Int. Cl. G06F 11/32; G06F 11/30; G06F 11/34; G06T 11/20

(52) U.S. Cl. CPC G06F 11/32; G06F 11/3037; G06F 11/3409; G06T 11/206

(57) ABSTRACT

Techniques for performing memory operations are disclosed herein. The techniques include obtaining statistics for operation of a device, the statistics including either or both of performance statistics and memory access statistics; generating a plurality of visualizations of the statistics in one of an overlay mode or a scene annotation mode; and displaying the plurality of visualizations.

### BACKGROUND

Computation performance depends in part on memory performance. Improving computation performance can thus be achieved by optimizing memory accesses. Further, increasingly specific insight into memory access performance can, at least theoretically, provide an increasing ability to improve performance. However, attempting to obtain such specific insight can, itself, impact performance, which can skew measurements, resulting in inaccurate measurement results. Improvements in performance profiling are constantly being made.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2A illustrates details of the device of FIG. 1, according to an example;

FIG. 2B illustrates example operations for a logger;

FIG. 3 illustrates example operations for a logger;

FIG. 4 is a flow diagram of a method for performing memory operations, according to an example;

FIG. 5A illustrates generating visualizations according to an overlay technique, according to an example;

FIG. 5B illustrates generating visualizations according to an annotation technique, according to an example;

FIG. 5C illustrates a memory trace and a corresponding memory visualization for a frame, according to an example;

FIG. 6A illustrates a rendered frame with a generated overlay, according to an example;

FIG. 6B illustrates a rendered frame including annotated scene geometry, according to an example; and

FIG. 7 is a flow diagram of a method for generating and displaying visualizations for recorded performance and/or memory access statistics, according to an example.

### DETAILED DESCRIPTION

Techniques for performing memory operations are disclosed herein. The techniques include obtaining statistics for operation of a device, the statistics including either or both of performance statistics and memory access statistics; generating a plurality of visualizations of the statistics in one of an overlay mode or a scene annotation mode; and displaying the plurality of visualizations.

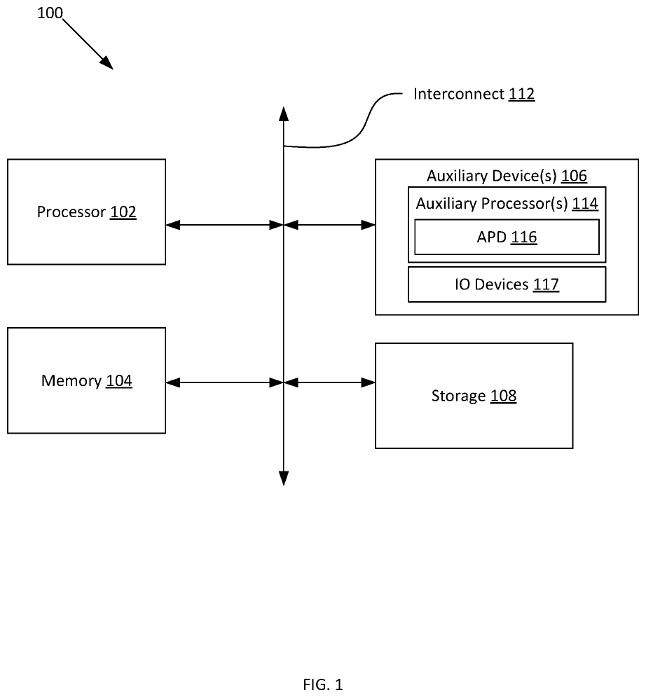

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes an accelerated processing device (“APD”) 116. The APD 116 may be coupled to a display device, which, in some examples, is a physical display device or a simulated device that uses a remote display protocol to show output. The APD 116 is configured to accept compute commands and/or graphics rendering commands from processor 102, to process those compute and graphics rendering commands, and, in some implementations, to provide pixel output to a display device for display. As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide graphical output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

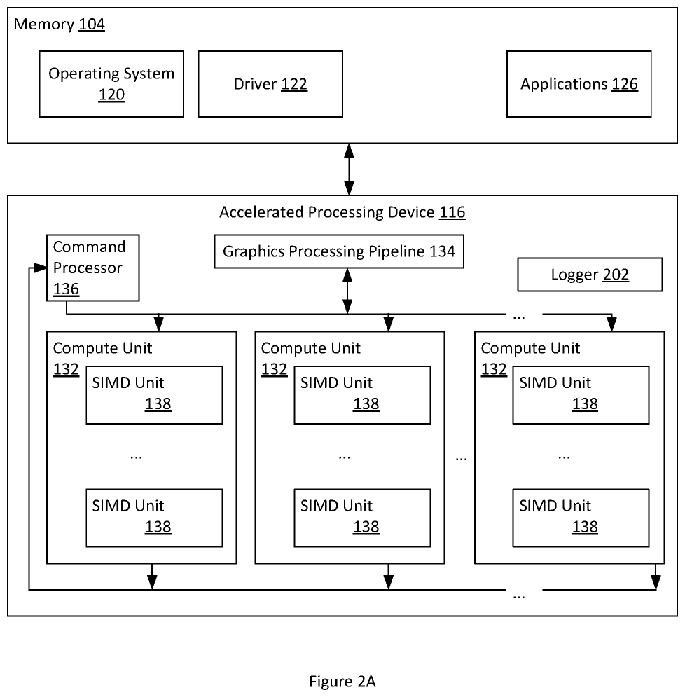

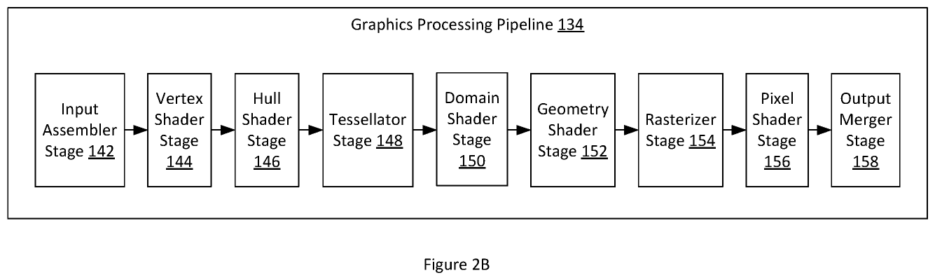

FIG. 2A illustrates details of the device 100 and the APD 116, according to an example. The processor 102 (FIG. 1) executes an operating system 120, a driver 122 (“APD driver 122”), and applications 126, and may also execute other software alternatively or additionally. The operating system 120 controls various aspects of the device 100, such as managing hardware resources, processing service requests, scheduling and controlling process execution, and performing other operations. The APD driver 122 controls operation of the APD 116, sending tasks such as graphics rendering tasks or other work to the APD 116 for processing. The APD driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to a display device based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that are configured to perform operations at the request of the processor 102 (or another unit) in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously (or partially simultaneously and partially sequentially) as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed on a single SIMD unit 138 or on different SIMD units 138. Wavefronts can be thought of as the largest collection of work-items that can be executed simultaneously (or pseudo-simultaneously) on a single SIMD unit 138. “Pseudo-simultaneous” execution occurs in the case of a wavefront that is larger than the number of lanes in a SIMD unit 138. In such a situation, wavefronts are executed over multiple cycles, with different collections of the work-items being executed in different cycles. An APD scheduler 136 is configured to perform operations related to scheduling various workgroups and wavefronts on compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

FIG. 2B is a block diagram showing additional details of the graphics processing pipeline 134 illustrated in FIG. 2A. The graphics processing pipeline 134 includes stages that each performs specific functionality of the graphics processing pipeline 134. Each stage is implemented partially or fully as shader programs executing in the programmable compute units 132, or partially or fully as fixed-function, non-programmable hardware external to the compute units 132.

The input assembler stage 142 reads primitive data from user-filled buffers (e.g., buffers filled at the request of software executed by the processor 102, such as an application 126) and assembles the data into primitives for use by the remainder of the pipeline. The input assembler stage 142 can generate different types of primitives based on the primitive data included in the user-filled buffers. The input assembler stage 142 formats the assembled primitives for use by the rest of the pipeline.

The vertex shader stage 144 processes vertices of the primitives assembled by the input assembler stage 142. The vertex shader stage 144 performs various per-vertex operations such as transformations, skinning, morphing, and per-vertex lighting. Transformation operations include various operations to transform the coordinates of the vertices. These operations include one or more of modeling transformations, viewing transformations, projection transformations, perspective division, and viewport transformations, which modify vertex coordinates, and other operations that modify non-coordinate attributes.

The vertex shader stage 144 is implemented partially or fully as vertex shader programs to be executed on one or more compute units 132. The vertex shader programs are provided by the processor 102 and are based on programs that are pre-written by a computer programmer. The driver 122 compiles such computer programs to generate the vertex shader programs having a format suitable for execution within the compute units 132.

The hull shader stage 146, tessellator stage 148, and domain shader stage 150 work together to implement tessellation, which converts simple primitives into more complex primitives by subdividing the primitives. The hull shader stage 146 generates a patch for the tessellation based on an input primitive. The tessellator stage 148 generates a set of samples for the patch. The domain shader stage 150 calculates vertex positions for the vertices corresponding to the samples for the patch. The hull shader stage 146 and domain shader stage 150 can be implemented as shader programs to be executed on the compute units 132, that are compiled by the driver 122 as with the vertex shader stage 144.

The geometry shader stage 152 performs vertex operations on a primitive-by-primitive basis. A variety of different types of operations can be performed by the geometry shader stage 152, including operations such as point sprite expansion, dynamic particle system operations, fur-fin generation, shadow volume generation, single pass render-to-cubemap, per-primitive material swapping, and per-primitive material setup. In some instances, a geometry shader program that is compiled by the driver 122 and that executes on the compute units 132 performs operations for the geometry shader stage 152.

The rasterizer stage 154 accepts and rasterizes simple primitives (triangles) generated upstream from the rasterizer stage 154. Rasterization consists of determining which screen pixels (or sub-pixel samples) are covered by a particular primitive. Rasterization is performed by fixed function hardware.

The pixel shader stage 156 calculates output values for screen pixels based on the primitives generated upstream and the results of rasterization. The pixel shader stage 156 may apply textures from texture memory. Operations for the pixel shader stage 156 are performed by a pixel shader program that is compiled by the driver 122 and that executes on the compute units 132.

The output merger stage 158 accepts output from the pixel shader stage 156 and merges those outputs into a frame buffer, performing operations such as z-testing and alpha blending to determine the final color for the screen pixels.

It is desirable to understand what memory accesses are occurring at a fine-grained level and in real time. Computer systems often provide some degree of visibility into what memory accesses are occurring and when. However, such visibility is usually limited, such as by providing only an overall count of memory accesses during a long time period. Fine-grained access information, indicating which addresses memory accesses are directed to, and what times such memory accesses are made, are usually not provided by the hardware. Such information can be very useful. For example, fine-grained memory access information can allow an application developer to identify memory access bottlenecks in an application at a very fine-grained level (e.g., to understand which accesses, made at which times, are problematic), which can allow the application developer to improve application performance by adjusting aspects of operation such as ordering of memory accesses, grouping of memory accesses, or the like. In another example, fine-grained memory access information can be provided to a runtime performance analyzer that can adjust execution settings based on the memory accesses.

A logger 202 is illustrated in FIG. 2A. The logger 202 is configured to store performance event information into a performance log and to store memory access event information into a memory access log. The memory access events include events such as writes to memory and reads from memory. The memory access event information indicates, either implicitly or explicitly, memory addresses associated with the memory accesses. In other words, the memory access logs store indications of what memory accesses are performed as well as what memory addresses the memory accesses are directed to. The memory address information is provided at a certain level of granularity that is not necessarily the exact address. In some examples, the memory address specifies a large chunk of memory-a memory address range-in which the memory accesses are performed, but does not provide more specific information than that. Both the performance event information and the memory access event information include or are associated with time periods or other ordering information that indicates the “time” for the associated performance events or memory access events. In some instances herein, this “time” is referred to as an epoch. In addition, the performance event information for a certain time includes memory access event references that point to associated memory access event information for that same time. These memory access event references allow correlation of performance events with memory access events, for example, during subsequent analysis or use of the performance event information and memory access event information.

As stated above, the performance event information for a certain time period includes references to memory access event information for the same time period. These references allow subsequent processing to correlate performance events with memory accesses. Performance events may indicate a variety of aspects of performance, such as processing throughput, processing latency, memory access performance (e.g., amount of data successfully accessed in a given amount of time), or other aspects. In general, the performance events indicate how well the computing device 100 is performing in a given time period, and any of a variety of measures for such performance may be used. Associating such performance events with memory access events allows subsequent analysis to first detect a performance level of interest (e.g., a drop in performance) and then to determine which memory accesses occur at that time period, and which addresses are associated with such memory accesses. In some examples, this determination allows the analysis to determine that the way in which certain memory accesses that are performed results in a particular drop in performance, or more generally to determine that some aspect of the memory accesses themselves or of processing related to the memory accesses results in, results from, or is otherwise associated with a particular drop in performance.

The logger 202 is capable of recording which memory addresses the various memory accesses are targeting. In some examples, the address resolution for which such tracking occurs is variable by the logger 202, either automatically or at the request of a different unit. The address resolution refers to the size of the memory access range for which the logger 202 stores individual items of memory access information. For example, with a 256 byte address resolution, the logger 202 stores items of memory access information for accesses within 256 byte address ranges. In an example, for a first “time,” the logger 256 detects memory accesses to addresses within a first 256 byte range and records such memory accesses as the memory access event information for the first time and for the first 256 bytes. The logger 202 thus stores information indicating that the detected number of memory accesses has occurred during the first time. No information is stored indicating which memory addresses within that 256 byte range the memory accesses occurred to. As can be seen, the address resolution indicates the specificity with which memory access events are recorded.

The logger 202 records performance events on a per time basis and records memory access events on a per time basis as well. In some examples, the logger 202 records a single performance event entry for a given time and records multiple memory access event entries for a given time. Each performance event entry stores performance event information for a particular time. Each memory access event entry stores memory access event information for a particular combination of time and memory address range. In other words, in such examples, the logger 202 stores, for each time, one item of performance event information and multiple items of memory access event information, where each item of memory access event information is for a different memory address range. Each item of performance event information includes a set of performance events for a time and for multiple memory address ranges and each item of memory access event information is associated with a time and a memory address range and includes indications of which memory accesses to that memory address range occur in the associated time. It should be understood that performance event information is not specific to any memory address range and thus covers multiple memory address ranges (or can be considered to cover the entire memory address space).

In some examples, the memory addresses tracked by the logger 202 are in a physical address space, as opposed to a virtual address space. A physical address space is the address space of the physical memory devices, whereas a virtual address space is the address space that is mapped to the physical address space and is thus independent from the physical addresses of the memory devices. Typically, an operating system and/or hardware (e.g., a memory controller) maintains information mapping virtual address spaces to physical address spaces. When applications or other software or hardware requests access to memory using a virtual address, the operating system and/or hardware translates such virtual addresses to physical addresses to access the memory.

The address range size for the memory access event information tracked by the logger 202 may or may not be the same as the virtual address memory page size. A virtual address memory page is a portion of contiguous addresses for which a memory address translation occurs. More specifically, typically, a virtual address has a portion (typically the most significant bits) that is considered the virtual memory page address. It is this portion that is translated to a physical address memory page. Obtaining a finer granularity physical address occurs by translating the virtual memory page address to a physical memory page address and then adding an offset. The offset is a portion of the virtual memory address other than the virtual memory page address. The size of the address range may be different from or the same as this virtual memory page size.

In some examples, it is advantageous to have the tracking address range size be smaller than or equal to the virtual memory page size. This is because if the tracking address range size were larger than the virtual memory page size, then it would be possible to track in any particular item of memory access event information, information from multiple unrelated virtual memory pages, which may not be desirable. That is, tracking information from multiple unrelated virtual memory pages could result in an inability to discriminate between virtual memory pages for the aggregate states tracked in a single item of memory address tracking information. Thus, in some examples, the logger 202 limits the memory address range size to equal to or smaller than the virtual memory address page size.

Above, it is stated that performance information and memory access event information is tracked for particular “times.” The term “time” is defined broadly herein. Time does not necessarily refer to wall clock time or to chip clock time or some other similar measure, although in some examples, time does refer to one such measure. Alternatively, it is possible for “time” to be measured by relation to number of tracked events occurring. In an example, “time” advances when an event that is tracked occurs. For example, when a memory access occurs, time is incremented. In another example, time is advanced for each byte of memory that is accessed over a data fabric (connection between requestor and memory) or for each byte accessed in a memory. In yet another example, time is advanced where a reference clock is advanced. Thus, in this example, in any particular item of memory access event information, a certain number of memory access events is stored. In other words, in some examples, the logger 202 tracks a certain number of events. In another example, in any particular item of performance event information, a certain number of performance events is stored.

In some examples, each item of performance event information and each item of memory access event information corresponds to an “epoch.” Each epoch ends when an epoch end event occurs. In some examples, an epoch end event occurs when an item of performance event information overflows or when an item of memory access event information overflows. In some examples, an overflow occurs when the storage available in an item of performance event information or in an item of memory access event information overflows. In some examples, an overflow occurs when sufficient data has been tracked such that the amount of storage available is zero or is insufficient to store more data, for at least one item of tracked data-in other words, where there is no space left in the storage to store additional data. In some examples, the storage that overflows can track any type of information. In some examples, storage overflows when a number of performance events or memory access events is equal to a maximum for any item in a given epoch. In other examples, storage overflows when a count for statistic information for an item of performance event information or for an item of memory access event information reaches a maximum value (e.g., for an 8-bit counter, reaches 255). When an overflow occurs, a new epoch, with new items of performance event information and memory access information, is started. It should be understood that an item of memory access event information for a given address range in a given epoch can overflow before any other item of memory access event information for a different address range in the same epoch overflows. In that instance, a new epoch is started, both for the performance event information and for all items of memory access event information. In some examples, each item of performance event information includes one or more pointers to one or more items (or all items) of memory access event information in the same epoch as the item of performance event information.

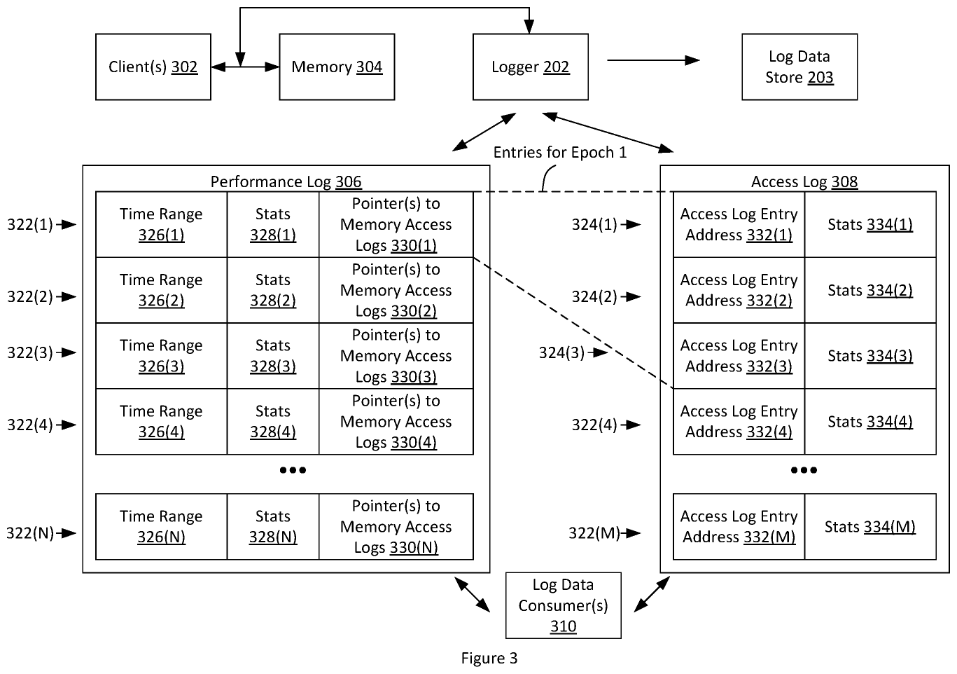

FIG. 3 illustrates example operations performed by the logger 202. The logger 202 interfaces with one of more clients 302 and one or more memories 304. Specifically, the logger 202 monitors performance events for the client(s) 302 and memory 304, monitors memory accesses from the clients 302 to the memory 304, and records such events in the performance log 306 and access log 308.

In some examples, the clients 302 are any unit of the device 100 that are capable of making memory access requests. In some examples, such units include the processor 102 and the APD 116, as well as any other unit capable of making memory access requests, such as an auxiliary processor 114 or IO device 17. In various examples, the logger 202 is embodied as hardware (e.g., circuitry configured to perform operations described herein), software executing on a processor, or a combination thereof.

As the logger 202 monitors the performance events and memory access events, the logger 202 generates performance log entries 322 and memory access log entries 324. In some examples, the performance log entries 322 are the items of performance event information discussed above. In some examples, the memory access log entries 324 are the items of memory access event information described above. The logger 202 observes performance events and memory access events, extracts or generates information about such events, and writes such information into the performance log entries 322 and memory access log entries 324 as described elsewhere herein.

Each performance log entry 322 includes a time range 326, statistics 328, and one or more pointers to memory access logs 330. In some examples, the time range includes an indication of a reference clock that measures actual time (e.g., wall clock time) or that measures system clock time (e.g., number of cycles since an initial point) or that is based on system clock time for any clock of the device 100. Note that this time range 326 is not necessarily the same type of time as the time that defines which “epoch” an entry is within, as the epoch may be based on the ordering of performance events or memory access events. Storing the time range 326 explicitly in the performance log entry 322 provides the ability to link a particular epoch to an actual point in time.

The statistics 328 include information about the performance events that are tracked. Some example statistic information is for the given epoch (e.g., occurs within that epoch) and includes: the number of data fabric bytes written or read, for one or more memory types (e.g., cache, memory, or other memory type), the number of bytes written to, read from, and/or prefetched into each such memory type, the number of read instances and number of bytes involved in a compression read/modify/write operation, a number of compression metadata bytes read from or written to a memory, the number of burst writes or reads, the amount (e.g., percentage) of bandwidth used for one or more of memory, cache, or data fabric, power management events, and user-defined events which are definable by an entity such as software. Performance log entries 322 include one or more of these items of statistic information.

The number of data fabric bytes written or read includes the number of bytes written or read using a data fabric. A data fabric is the connection between clients 302 and memory 304. Data fabrics can have a capacity (e.g., bandwidth) independent of that of the memories or clients for which the data is written or read, and thus the ability to measure the number of bytes written or read can be useful to understand. The number of bytes read or written for one or more memory types is stored on a per memory type basis. In an example a number of bytes that are read from or written to a cache in an epoch is stored in the statistics for a particular entry 322 and the number of bytes that are read from or written to a memory in the same epoch is also stored in the statistics for that entry 322. In some examples, memory accesses are accessed to compressed data, where compression is a hardware supported operation. In some such examples, the logger 202 separately maintains the number of bytes read, written, or modified for compressed data and for uncompressed data. Thus, in some such examples, the statistics 328 for a particular entry 322 include a number of bytes read, written, or modified for uncompressed data within an epoch, and a number of bytes read, written, or modified for compressed data within the same epoch. In addition, compressed data can include or require additional metadata that specifies information required for compressing or decompressing the data or that is otherwise useful to the compression operation. In some examples, the statistics 328 store the amount of such metadata that is stored in the epoch. In some examples, memory accesses are of a burst type and a non-burst type. Generally, burst type accesses are accesses to relatively large amounts of data that is contiguous in the physical address space, whereas non-burst type accesses are accesses to individual items of data (e.g., individual words). In some examples, the statistics 328 separately store a count of burst-type accesses, in addition to a count of non-burst type accesses. The bandwidth information includes the percent (or other measure) of bandwidth capacity actually used for a memory or data fabric within the mentioned epoch.

For any given performance log entry 322 for a particular epoch, the pointers 330 to access logs 330 include pointers to the access log entries 324 for that epoch. In some examples, a single performance log entry 322 for an epoch includes pointers to all access log entries 324 in the access log 308 for that same epoch. Each access log entry 324 includes an access log entry address 332 and access log statistics 334. The access log entry address 332 for an access log entry 324 specifies the address range of the statistics 334 for that access log entry 324. More specifically, the entire access log 308 has an address range size (the “address resolution” described above) which specifies the granularity with which memory accesses are tracked. This address range size also indicates the range of memory addresses after the access log entry address 332 that is tracked by an access log entry 324. In other words, each access log entry 324 tracks addresses between the access log entry address 332 and the access log entry address 332 added to the address range size. The stats 334 include information about the memory accesses tracked within the corresponding address range specified by the access log entry 332. It should be seen that a performance log entry 322 for an epoch includes statistics 328 about multiple different address ranges that occur within an epoch, and each such address range has a different access log entry 324, each of which includes statistics 344 about the memory accesses made to the address range within the epoch.

The statistics 334 include any combination of the following, all for the epoch and the memory address range of the access log entry 324: the number of bytes returned over the data fabric, the number of bytes written over the data fabric, the read compression ratio, the write compression ratio, the number of bytes written to or read from a memory (which such number can be stored independently for different types of memories, such as memory, caches, or other types of memories), the number of bytes prefetched into a memory, the number of bytes rinsed, the number of reads caused by compression operations, the number of atomic memory operations performed, the cache policy (including, for example, whether allocations are allowed into the cache, where allocations occur when a miss occurs, in order to store missed data into the cache, re-reference interval prediction data, which indicates the amount of “time” between re-references of a cache line), user-defined data, or any other type of information that could be stored. The read compression ratio is the ratio of the size of compressed data to the size of uncompressed data for read operations and the write compression ratio is the ratio of the size of compressed data to the size of uncompressed data for write operations. The number of reads caused by compression operations includes how many reads to data actually occur due to a compression operation. For example, reading from compressed data or writing compressed data may require reading or writing of data other than the actual data compressed, and this other data can include compression metadata or other data of a compressed block (since data may be compressed together and thus operation on one portion of compressed data may require other operations on other data that is compressed together).

Log data consumers 310 are illustrated in FIG. 3 as well. These log data consumers 310 include one or more of a log data backup agent and/or a log data analyzer, either of which is embodied as hardware (e.g., circuitry), software executing on a processor, or a combination thereof. A log data backup agent stores the information from the performance log 306 and/or the access log 308 into one or more backup memories. The one or more backup memories include one or more of the memory 104, memories within the APD 116, storage 108, or other memories. The log data backup agent transfers the data from the performance log 306 and/or access log 308 when either of those logs run out of room (e.g., when a new entry is to be created but there is no space left), or in response to any other technically feasible event. The log data analyzer analyzes the performance log 306 and/or access log 308. In some examples, the log data analyzer analyzes these logs to determine how to adjust the operation of the device 100 for better performance, and/or analyzes these logs to generate and provide conditioned information for consumption by another system or for a human (e.g., for a human developer developing an application who will use profiling data to improve performance of the application). In some examples, the log data analyzer is embodied as multiple parallel programs (such as compute shader programs executing on the APD 116). The data in the performance log 306 and access log 308 is organized to facilitate efficient parallel processing of such data. In an example, one parallel execution item (e.g., a first compute shader work-item or wavefront) analyzes a first access log entry 324 during a time period in which a second parallel execution item analyzes a second access log entry 324. Both such parallel execution items produce a result for such analysis in parallel, which is used by a different execution item (such as a compute shader work-item or wavefront or even a thread on the processor 102). In some examples, a different parallel execution item analyzes the performance logs 322 in parallel with the first and second parallel execution item as well. In some examples, a parallel execution item analyzes a performance log entry 322, fetches the pointers 330, and spawns further parallel execution items to analyze the access log entries 324 pointed to by the pointers 330, along with information from the analysis of the performance log entries 322. In some examples, a single execution item processes information in or derived from multiple access log entries 324. In some examples, a single execution item processes information from different epochs. In some such examples, the single execution item aggregates information from different epochs, for example, by combining statistics for smaller address ranges and single epochs to generate statistics for larger address ranges and longer epochs.

In some examples, the logger 202 filters information, preventing that information from being written to the performance log 306 and/or the access log 308. In some such examples, the logger 202 references data indicating the processes, virtual machines, or other entities for which logging is allowed and ignores (does not log for) accesses for which logging is not allowed. In an example, an application that has logging disabled makes memory accesses, but the logger 202 does not include information about such memory accesses in the performance log 306 and/or access log 308.

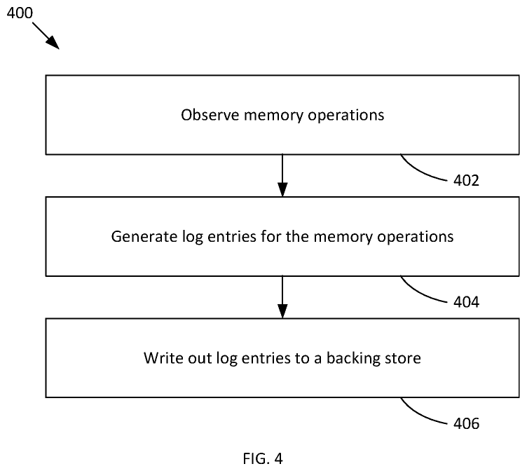

FIG. 4 is a flow diagram of a method 400 for performing performance-related and memory-related operations, according to an example. Although described with respect to the system of FIGS. 1-3, those of skill in the art will understand that any system, configured to perform the steps of the method 400 in any technically feasible order, falls within the scope of the present disclosure.

At step 402, a logger 202 observes operations for one or more clients 302 and/or one or more memories 304. The operations include one or more of the operations described above with respect to the information that is stored in the performance log 306 and/or the access log 308. At step 404, the logger 202 generates entries for either or both of the performance log 306 and the access log 308 based on the observed operations. In some examples, the logger 202 operates based on epochs. An epoch is a certain amount of “time,” where “time” is measured as described herein. An epoch begins after a previous epoch ends and an epoch ends when an epoch end event occurs, as described elsewhere herein. When an epoch end event occurs, the logger 202 generates an entry for the performance log 306 and one or more entries for the access log 308. As described elsewhere herein, a generated performance log entry 322 includes stats 328 for an epoch and pointers to one or more access log entries 324, each of which is associated with a memory address range and includes statistics 334 for that memory address range. At step 406, the logger 202 writes out log entries (e.g., the performance log entries 322 and the memory access log entries 324) to a backing store such as the log data store 203. In some examples, this operation occurs when new entries are to be placed into a log and insufficient space exists for such entries, or occurs on any technically feasible trigger, such as periodically. One or more log data consumers 310 may process the information from the performance log 306 and access log 308, either in those logs or after such information is written to the backing store. In various examples, the performance log 306 and access log 308 are stored in memories of the logger 202, dedicated to the logger 202, or in memory that is more general and shared with other units (such as general memory of the APD 116).

One benefit of the logger 202 is that it is possible to display the information gathered by the logger 202 in a helpful way for immediate appreciation by a user (e.g., an application developer). Such display can present any technically feasible information, such as any of the information recorded by the logger 202 and described herein. Such information can allow a person such as an application developer to debug, profile, and/or improve performance of the application for which the logger 202 collects information.

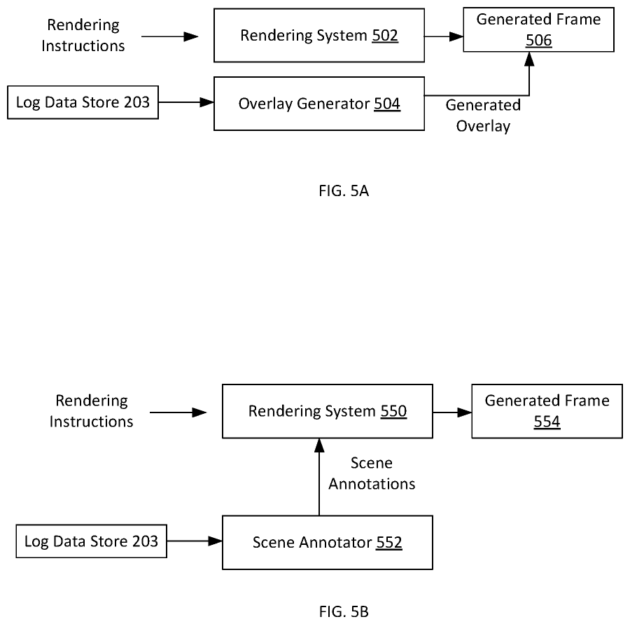

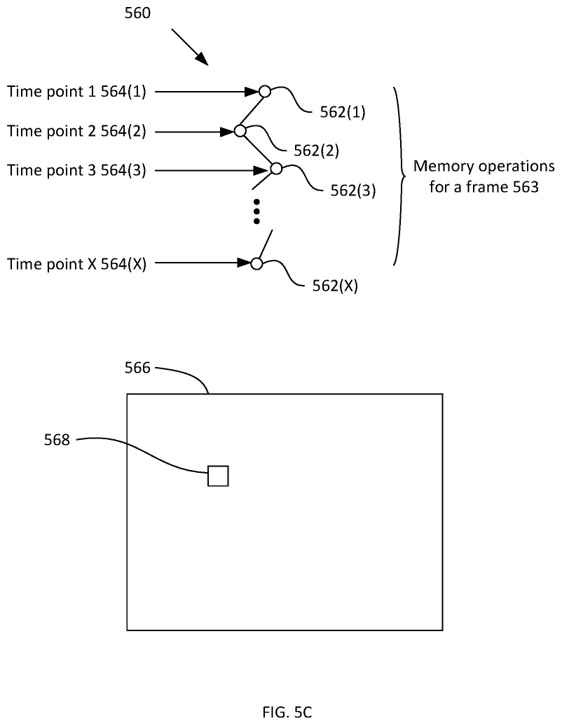

Two techniques are provided herein by which such information can be presented: an overlay technique (FIG. 5A) and a scene annotation technique (FIG. 5B). The overlay technique could be applicable to 3D scene rendering as well as a way to augment visualization of memory contents. In the 3D rendering overlay technique, a rendering system 502 generates a rendered image and an overlay generator 504 generates a corresponding overlay. The overlay generator 504 or other system combines the generated overlay with the generated image to generate a generated frame 506 with overlay. The overlay includes information derived from the log data store 203, which may be related to the information shown by the rendering system 502. The visualization-augmenting overlay technique could be applicable to inputs of 3D rendering or inputs and outputs of the general compute operations. The overlay includes information derived from the log data store 203, which is superimposed on memory content visualization, such as visualization of a texture. In the scene annotation technique, a rendering system 550 generates an image. A scene annotator 552 generates annotations to the scene based on the log data store 203 and incorporates the annotations into the image generated by the rendering system 550 to generate the generated frame 554. In some examples, the annotations include modifications to the content generated by the rendering system 550 (for example, changes in pixel colors rendered by a rendering system, where the changes are dependent on information stored in the log data store 203). In some examples, the scene annotator 552 is at least partially incorporated into the rendering system 550. In some examples, the annotations generated by the scene annotator 552 differ from the overlay generated by the overlay generator 504 in that the annotations are incorporated into the content of the scene, rather than simply being overlaid over the scene. In some examples, incorporation of the content into the scene includes modifying the content generated by the rendering system 550 in a way that is not possible with an overlay. In some examples, the scene annotator 552 is at least partially incorporated into a pixel shader program executing in a pixel shader stage 156 of a graphics processing pipeline 134. In some examples, the scene annotator 552 generates colors or color modifications that are applied to colors of pixels processed by a pixel shader stage 156. These colors or color modifications are the scene annotations described above. In some examples, these modifications are applied within the pixel shader stage 156. As can be seen, in such examples, the annotations are incorporated into the logical processing of the scene as opposed to being overlaid over a scene. In other words, where overlays are simply placed over an image generated by a rendering system 502, the scene annotations are used to generate content in a manner similar to the rendering system 502 or in the course of rendering images by the rendering system 502. For simplicity, the term “memory visualization” refers collectively to either an overlay or a portion thereof (e.g., a visual element) or a scene annotation. Additionally, for simplicity, the term “memory visualization generator” refers collectively to either the overlay generator 504 or the scene annotator 552.

The rendering system 502, overlay generator 504, rendering system 550, and scene annotator 552 are each embodied as software executing on a processor, hardware (e.g., any type of processor such as a programmable or fixed function processor, or any other circuit), or a combination thereof. In some examples, the rendering system 502 or rendering system 550 include, comprise, or are part of the APD 116.

In some examples, the memory visualizations are based on memory traces. A memory trace is a sequence of memory accesses that are evaluated during rendering or execution of general compute operations. Such operations could be viewed as being part of a processing dependency chain. A dependency chain is a sequence of operations in which earlier operations produce results that are consumed by later operations. The later operations in such a chain are considered to be dependent on the earlier operations in such a chain. Analysis of memory accesses within a context of such dependency chains allows establishing temporal association of memory accesses with operations. In some examples, the overlay generator 504 or scene annotator 552 analyze the data of the log data store 203 to identify memory traces and displays information based on such memory traces.

In some examples, the memory visualization generator generates memory visualizations in a manner that is associated with a dependency chain (or memory trace). More particularly, the memory visualization generator generates memory visualizations for a “current” point in time. At the request of an entity such as an application or a user, the memory visualization generator is capable of “scrubbing” this current point in time backwards or forwards in time, adjusting the visualizations generated accordingly. The “current” point in time determines the time of the memory accesses for which the visualization generator generates memory visualizations. Thus, scrubbing the current point in time backwards or forwards follows the memory traces in time and adjusts the memory visualizations that are displayed. For example, scrubbing backwards in time follows the dependencies of the memory traces backwards and scrubbing forwards in time follows the dependencies of the memory traces forwards, adjusting the visualizations accordingly. In some examples, this “scrubbing” occurs automatically (e.g., at the direction of the memory visualization generator itself or at the direction of any other element) or manually (e.g., in response to a user input).

As should be understood, generating a frame of rendered graphics includes performing a large number of memory accesses in sequence over a period of time. Thus, in some examples, the memory visualization generator is capable of generating memory visualizations for different points in time for rendering of a particular frame. In other words, it is possible to include, with a particular frame, memory visualizations for any particular point in time during rendering of that frame. By scrubbing forwards or backwards, it is possible to visualize different points in time within the process of rendering a frame.

In some examples, in the course of generating a memory visualization for a particular frame, scrubbing backwards or forwards in time is limited to the times at which operations are being performed for rendering that frame. Thus, a user, or software, is able to view memory visualizations for different operations that are part of rendering a frame. It should be understood that a frame can be a frame generated by the graphics processing pipeline 134, by compute shaders, or by any other element. In other examples, there is no such timing limitation.

It should be understood that at any particular point in time, the memory visualization generator generates multiple individual memory visualizations for display. Each such individual memory visualization can be for a different set of memory accesses and thus for a different memory trace. In an example, the scene annotator 552 generates multiple individual memory visualizations for different portions of a frame and displays those memory visualizations. In such an example, each individual memory visualization is related to operations to determine the colors for different pixels or different sets of pixels. In an example, generating a particular pixel requires a set of operations beginning with operations transmitted from the processor 102, through the various stages of the graphics processing pipeline 134, to the result of writing the pixel color to a frame buffer for display. In some such examples, for any particular pixel, a trace includes the sequence of operations for generating that pixel. Thus, as part of visualization operations for a frame, the scene annotator 552 generates memory visualizations for such different traces/pixels. In some examples, such annotations include a color tint for a corresponding pixel, where the tint is related to statistics collected for related memory accesses, such that each pixel is tinted by a color corresponding to aspects of an associated memory trace. In such an example, scrubbing through the time of the frame causes such tint to change based on the statistics for the memory accesses at a current point in time as the scrubbing occurs.

FIG. 5C illustrates a memory trace 560 and a corresponding memory visualization 568 for a frame 566, according to an example. The memory trace 560 includes memory operations 562 that occur in the course of generating a frame (memory operations for a frame 563). In addition, the different memory operations 562 occur at different time points 564 as shown.

The illustrated frame 566 is an image generated by, for example, the graphics processing pipeline 134 or another entity such as a compute shader. The memory visualization 568 is a visualization of an aspect of memory accesses for a trace at a given time point 564 such as time point 2 564(2). Scrubbing the time ahead moves the time point for which the memory visualization 568 generates information to a later time point 564 (for example, time point 3 564(3)), which modifies what the memory visualization 568 shows. Scrubbing the time before moves the time point to an earlier time point 564 (for example, time point 1 564(1)), which, again, modifies what the memory visualization 568 shows.

Although only a single memory visualization 568 is shown, it should be understood that any number of memory visualizations 568 can be shown at any given time. For example, one memory visualization 568 could be provided per pixel or per block of a rendered frame. Alternatively, one visualization 568 could be provided for each address range within a larger address range of interest. In another example, visualization 568 could be provided for a range of the time points 564.

In various examples, the traces from which memory visualizations 568 are generated are selected based on a specific item associated with a specific memory access of the trace. In some examples, this specific item can be any feature input by or output by the graphics processing pipeline 134 or compute shader. This feature represents one memory access at one time point 564, from which the remainder of the trace is determined. In an example, if a write into a frame buffer (e.g., of a color) is the final memory access at the final time point (e.g., time point X 564(X)), then the trace is the trace associated with that memory access. More specifically, the trace is the trace that includes the write into the frame buffer as well as the prior memory operations on which that final write depend (e.g., pixel shader memory operations, texture accesses, vertex shader memory operations, and others). In some examples, selection of a trace is based on other items such as specific resources (e.g., texture) accessed, or other types of resources read from or written to. In some examples, selection of a trace is made based on a particular stage of the graphics processing pipeline such as the pixel shader stage or the vertex shader stage.

In some examples, a trace is selected for each memory visualization, a time point is selected for each trace, and the memory visualization generator generates the memory visualization based on the trace and the time point. In some examples, a memory visualization is generated for each pixel of a frame, for each memory range of a set of memory ranges for which visualization is desired, or for each resource or other item for which visualization is desired. In some examples, the settings (which resource or other item, which time point, etc.), for generation of the memory visualization are selected by a human user or automatically (e.g., by software).

As described, the visualizations are generated based on traces. In some examples, the memory visualization generator generates a trace based on knowledge of a sequence of memory accesses. In an example, the memory visualization generator is provided with knowledge of the series of operation performed by the graphics processing pipeline 134. Thus, the memory visualization generator is able to, and does, determine which addresses are involved in a trace. In some examples, the memory visualization generator uses the time stamps stored in the log data store 203 to determine which accesses belong to which traces.

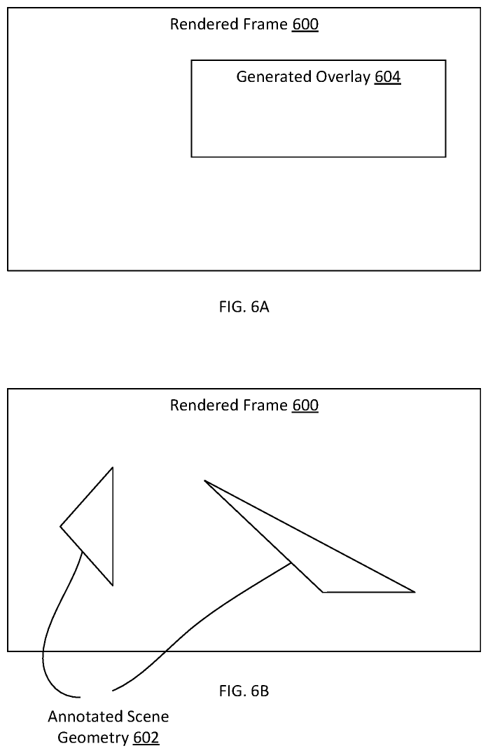

FIGS. 6A and 6B illustrate additional detail related to specific techniques for generating memory visualizations, according to examples. Specifically, FIG. 6A illustrates generated overlays and FIG. 6B illustrates scene annotations.

FIG. 6A illustrates a rendered frame 600 (which is also or alternatively, in some examples, a 2D visualization of a resource or a memory region) with a generated overlay 604, according to an example. A rendered frame 600, including content (not shown) and a generated overlay 604 are shown. The generated overlay 604 includes information related to the content of the rendered frame 600. As described above, the logger 202 records performance statistics 328 and memory access statistics 334 for memory accesses made, and records time information for such statistics. It is possible to display any combination of such time information and statistics in any configuration within the generated overlay 604. In some examples, the overlay generator 504 selects a time frame, either automatically (e.g., based on scrubbing through a trace or through other means), or based on input from a program or human computer user (e.g., application developer), selects one or more types of performance statistics 328 and/or memory access statistics 334, and generates a visualization for such information. Such visualization can be any technically feasible visualization, such as a two-dimensional or three-dimensional graph, a grid, a histogram, a chart, a plot, a custom visualization, or any or technically feasible type of visualization. In some examples, the overlay generator 504 obtains, from the log data store 203, statistics associated with a particular time frame and a particular address range and generates a visualization as described above for such information. In some examples, the address range selected is based on scrubbing through a trace or through other means.

In various examples, where time range and statistics are used, but address ranges are not used, the overlay generator 504 generates one or more visual elements for each time period within a time range. Each visual element illustrates aspects of one or more statistics of the stored statistics. Thus, in such examples, a visualization includes a plurality of visual elements, each illustrating a time period and set of one or more statistics. The illustrated statistics include any of the performance statistics 328 and/or the memory access statistics 334.

In some examples, the overlay generator 504 notes the time range requested and obtains the performance log entries 322 and memory access log entries 324 for that time range. The time range may correspond to one or more epochs. In examples where the time range is specified in real time, as opposed to the “time” associated with epochs, the overlay generator 504 obtains the one or more performance log entries 322 whose time ranges 326 fall within the specified time range, obtains the statistics desired to be visualized, and generates visual elements for those statistics. The statistics are performance log statistics 328 and/or memory access log statistics 334. In examples where the statistics include performance log statistics 328, the overlay generator 504 obtains the performance statistics 328 from the performance log entries 322 that correspond to the times. In examples where the statistics include memory access log statistics 334, the overlay generator 504 obtains the memory access log statistics 334 that correspond to the time point for the visual element, and generates the visual element for those memory access log statistics 334. In some examples, for a particular visual element, the overlay generator 504 obtains one or more of the memory access log statistics 334 pointed to by the performance log entries 322 corresponding to that time point. In some examples, the overlay generator 504 obtains all such memory access log elements 324 and combines the statistics 334 for such memory access log elements 324 to generate the visual element.

In various examples, any of a variety of aspects of the visual element may be adjusted by the overlay generator 504 to provide an indication of the statistics being displayed. In various examples, size, position, color, transparency, rotation, or other aspects are adjusted by the overlay generator 504 to provide such indications. In some examples, a graph is shown that graphs a statistic over time. In some examples, a graph is shown that graphs a statistic over time. The overlay generator 504 plots a point for each time point, where each point corresponds to a value of the statistic at a different time. In such examples, the height of the point corresponds to the value of the statistic. In various examples, where a visual element is generated for a statistic within a time period, the statistics actually recorded in that time period or derived from memory traces are combined in any technically feasible way (e.g., summing, averaging, or using other techniques) to generate the visual element.

In some examples, the overlay generator 504 generates visual elements, each associated with a different time point and address range. In some such examples, each visual element is associated with a particular address range and time range. In such examples, to generate a visual element, the overlay generator 504 obtains the statistics for the time point and address range, i.e., by traversing from the performance log entry 322 for that time point to one or more memory access log entries pointed to by that performance log entry 322 and which falls within the address range. The overlay generator 504 collects the statistics corresponding to that time point and address range, and generates a visual element based on those statistics. As above, any technically feasible visual aspect of the visual elements may be adjusted to illustrate the value of the statistic. In an example, a two-dimensional visual representation of an address space for a particular time point is used, where each visual element corresponds to an element of the two-dimensional visual representation. Each such element has one or more visual aspects that illustrate the statistic(s) tracked. Any manner in which the visual elements are displayed to illustrate the combination of time and statistics may be used by the overlay generator 504.

In summary, in the overlay generator 504 generates an overlay 604 that includes a number of visual indicators that visually indicate one or both of performance statistics and/or memory access statistics. The statistics used could also be derived from performance and/or memory statistics, directly or indirectly. Each visual indicator is associated with a time point and, optionally, a memory access range. Each visual indicator visually indicates a value of one or more statistics at a corresponding time point. The overlay thus provides an indication for a plurality of statistics at one or more time points, based on the data in the log data store 203.

It is possible for the overlay generator 504 to change what statistics are visualized, what time points are visualized, and what memory address ranges are visualized. Such changes can occur automatically, e.g., due to a programmed sequence, or in response to input from software, hardware, or a user. Thus, the overlay generator 504 is able to display an overlay illustrating statistics at different capture times and for different memory address ranges.

FIG. 6B illustrates a rendered frame 600 including annotated scene geometry 602, according to an example. The annotated scene geometry 602 is rendered by a graphics processing pipeline 134 to generate an image in a way that includes an annotation associated with one or more statistics in the log data store 203. More specifically, the graphics processing pipeline 134 performs normal rendering operations, for example, converting geometry in world space to triangles with screen space coordinates, determining colors for pixels covered by those triangles, and outputting those colors to an output buffer for subsequent use (e.g., for display or to be used for further processing). In the course of this processing, or separately from this processing, the scene annotator 552 generates modifications to the geometry in world space, the geometry in screen space, or the final output colors, where the modifications are reflective of one or more statistics in the log data store 203.

In some examples, a two-pass scheme is used. In the first pass, the scene is rendered and the logger 202 stores statistics data into the log data store 203 as described elsewhere herein. In a second pass, the scene annotator 552, in conjunction with the rendering system 550, uses the recorded statistics in the log data store to generate a scene with annotations.

In some examples, the scene annotator 552 is at least in part embodied as one or more shader programs executing as part of the one or more stages of the graphics processing pipeline 134. In some examples, the shader program is unmodified in the first pass and the modification is performed for the second pass. In various examples, the modifications made to the shader programs include modifications that adjust the output of the shader program based on the statistics of the log data store 203. Any technically feasible parameter of the outputs of the shader program can be varied.

In one example, the scene annotator 552 includes at least a portion of a pixel shader program executing in the pixel shader stage 156. In some examples, an application provides a pixel shader program and the scene annotator 552 or another entity such as the driver 122 modifies the pixel shader program to modify the output of the pixel shader based on one or more statistics in the log data store 203. In some examples, the modifications for the modified pixel shader program includes modifying luminance, color, transparency, visibility, depth, or another aspect of the pixel, based on one or more statistics in the log data store 203.

In another example, the scene annotator 552 includes at least a portion of a vertex shader program executing in the vertex shader stage 144. In some examples, an application provides a vertex shader program and the scene annotator 552 or another entity such as the driver 122 modifies the vertex shader program to modify the output of the vertex shader program based on one or more statistics in the log data store 203. In some examples, the modifications for the modified vertex shader program include modifying vertex position, texture coordinates, color, or other attributes.

In other examples, the scene annotator 552 includes at least a portion of another shader program, such as a hull shader program executing in the hull shader stage 146, a domain shader program executing in the domain shader stage 150, or a geometry shader program executing in the geometry shader stage 152. The modifications made in the second pass for such shader programs includes any technically feasible modification.

In summary, the above is a technique for generating annotations by modifying shader programs to generate output at least in part based on recorded statistics in the log data store 203. The technique is a two-pass technique in which a frame is first rendered normally and statistics corresponding to the frame are recorded in the log data store 203. The statistics are recorded for one or more time ranges, and the time ranges correspond to the operations that cause the frame to be rendered. Such activities include operations of the shader programs of the graphics processing pipeline 134, operations of the CPU used to generate requests to the graphics processing pipeline 134 to perform such rendering, operations related to memory or caches, or other operations. In a second pass, one or more modified shader programs modifies output based on the statistics stored in the log data store 203. In some examples, the statistics are associated with the operations of the shader programs. In an example, where a pixel shader program generates pixel output, the statistics used to modify that pixel output in the second pass are statistics related to generation of the unmodified color in the first pass. For example, if the pixel shader program reads from a texture to determine a color for the pixel, then in some examples, the modification is related to statistics for memory accesses to that texture, at the address read by the pixel shader program. If the pixel shader program reads other data, then the modification is related to statistics for that data read. Put simply, in some examples, the modification made to the output of a shader program is based on one or more statistics recorded for memory addresses used to generate the unmodified output for the shader program. The output of the shader program in the second pass can be output directly (e.g., as an image) or can be combined with the output from the output in the first pass to generate a combined or blended image that displays an annotated scene including indications of the statistics recorded in the log data store 203.

Above, it is stated that modifications are made to output of a shader program based on the statistics. Such modifications can be made in any technically feasible manner, to provide an indication of a statistic desired to be illustrated. In various examples, output values (e.g., color or any other value described herein) are adjusted upward or downward by a magnitude that is based on the magnitude of a statistic (any statistic described herein) to be illustrated. In an example, a lower hit rate causes the output color to shift to the color red to a greater degree than a higher hit rate. Thus, the modifications made to the output in the second pass visually reflect the values of the statistics recorded in any technically feasible manner.

In another technique, a rendering system 550 renders a frame and a scene annotator 552 generates annotations for the frame by back-tracing the memory accesses involved in generating the frame. More specifically, the scene annotator 552 is provided with information indicating a sequence of memory accesses that are used to generate the pixels of the image. For each particular pixel, the scene annotator 552 is thus able to identify which memory accesses and thus which statistics in the log data store 203 are associated with which pixels. In addition, the scene annotator 552 is provided (e.g., by a program or a human user) with an indication of which resources (e.g., which portions of memory) to display scene annotations for, as well as which statistics to display as scene annotations. For example, it might be desired to illustrate statistics for a particular texture used to generate a pixel, or for other resources used to generate the pixel. Based on the information indicating the ranges of addresses associated with each resource, as well as the sequence of resources used to render an image, and a selection of which resource is to be displayed as an annotation, a scene annotator is able to, for any particular pixel, identify the specific statistics associated with generating that pixel. The scene annotator uses those addresses to generate annotations related to the resources for which annotation is requested.

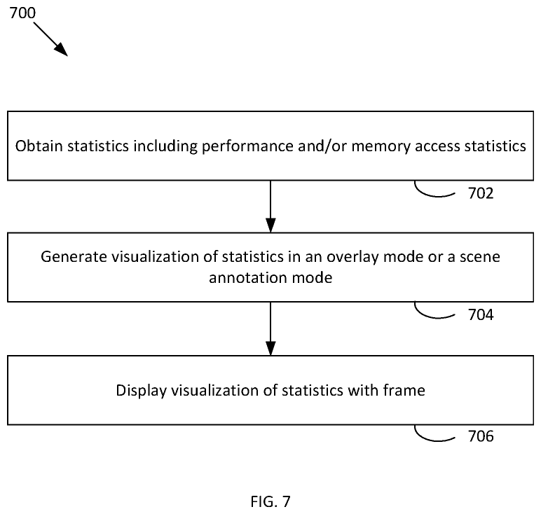

FIG. 7 is a flow diagram of a method 700 for generating and displaying visualizations for recorded performance and/or memory access statistics, according to an example. Although described with respect to the systems of FIGS. 1-6B, those of skill in the art will recognize that any system, configured to perform the steps of the method 700 in any technically feasible order, falls within the scope of the present disclosure.

At step 702, a logger 202 gathers performance statistics and/or memory access statistics. These statistics can be any of the types of statistics described herein or any technically feasible statistics. As described elsewhere herein, performance statistics include statistics about operation of the device for which performance is being logged, and are not associated with specific memory address ranges. Memory access statistics are associated with specific memory address ranges and include information about memory accesses for such memory address ranges or other information associated with such memory address ranges. Example performance or memory access statistics are described elsewhere herein.

In some examples, the statistics are obtained in a first pass. More specifically, in such a first pass, a system, such as a rendering system 502 (e.g., at least a portion of the APD 116 and/or software executing on a processor 102), a rendering system 550 (e.g., at least the graphics processing pipeline 134) generates an image, while the logger 202 records performance log entries 322 and/or memory access log entries 324 for the operations for generating such an image. In an example, the system generating the image is a rendering system 502, which is further embodied as one or more compute shader programs configured to generate an image (i.e., as a post-processing pass, modifying or generating contents based on another image or as an original pass, generating an image from data other than another image). In another example, the system generating the image is a rendering system 550, which is further embodied at least in part as the graphics processing pipeline 134 configured to render an image as described elsewhere herein. In either such example, the logger 202 logs one or more of the various performance statistics and/or memory access log statistics that occur in the course of generating the frame. Although an example technique is described for obtaining these statistics for step 702, any other technically feasible technique that results in obtaining these statistics is possible.

At step 704, a visualization generator generates visualizations of the statistics collected at step 702. In some examples, the visualization generator is the overlay generator 504, which generates an overlay, and in other examples, the visualization generator is the scene annotator 552, which generates scene annotations. As described elsewhere herein, the overlay generator 504 generates an overlay to display over a generated frame 506 or over a visualization of a memory region or a resource, and the scene annotator 552 generates scene annotations for incorporation into the generated frame 554. Regarding the overlay generator 504, the overlay generator creates any of a variety of visualizations based on the captured statistics and displays these visualizations as the overlay. As described elsewhere herein the visualizations include any technically feasible way of representing the data, including graphs, charts, plots, maps, histograms, or any other type of image representative of the data. Regarding the scene annotator 552, the scene annotator 552 modifies what is generated by the rendering system 550 based on the statistics. In an example, the scene annotator 552 operates in a second pass, where in a first pass, an image is rendered “normally” by a graphics processing pipeline 134. In the second pass, the scene annotator 552 generates output that has some characteristics of the frame generated by the rendering system 550 in the first pass but is also influenced by the captured statistics. In an example, in the second pass, the graphics processing pipeline 134 operates as in the first pass, with additional operations included in a shader program for applying modifications based on the statistics. In an example, one or more shader programs such as a pixel shader program performs at least one of the same operations as in the first pass, and includes an additional operation or is modified in a manner that reflects the statistic being visualized. In other examples, a vertex shader program calculates modifications to vertex attributes based on the statistic tracked. In other examples, a shader program executing in the second pass computes a modification to the value output by that shader program in the first pass, and the generated frame 554 reflects that modification applied to the output generated by that shader program in the first pass. In general, in such examples, a shader program executing in a second pass performs some computation that is based on the statistic tracked, and combines this computation with the “normal” output of that shader program, which is not based on the statistic tracked, to generate an output.

At step 706, an output mechanism displays a visualization of statistics with a frame. In various examples, the output mechanism includes a physical display, reading the frame data that includes visualizations from memory such as a frame buffer and displaying that data to a user. In another example, the output mechanism includes software or hardware, or a combination thereof, that is configured to transfer the frame including the visualizations to a volatile or non-volatile memory, to a destination across a network, or to any other destination.

Although it is described herein that the scene annotation technique may be performed as part of the graphics processing pipeline 134, it is also possible that the scene annotation technique is performed as part of a ray tracing pipeline. In some such examples, material shaders are modified to reflect statistics, such as those related to ray tracing, or other statistics, in the final output image, in a similar manner that the pixel shader is modified.

In various examples, the term “based on” as used herein means the following. If a first value is said to be based on a second value, then the first value varies as the second value varies. In some examples, the magnitude of the first value increases or decreases as the value of the second value increases or decreases, respectively. In some examples, this relation is reversed. In some examples, a mathematical formula can express a continuous relationship between the first value and the second value. In some examples, the first value is proportional to or inversely proportional to the second value. In some examples, there is a discontinuous relationship, with the relationship between the different values being represented by different mathematical formulas, each for a different range.

The various functional units illustrated in the figures and/or described herein (including, but not limited to, the processor 102, the auxiliary devices 106, auxiliary processors 114, the APD 116, the IO devices 117, the command processor 136, the compute units 132, the SIMD units 138, the logger 202, the clients 302, the memory 304, and the log data consumer(s) 310, may be implemented as a general purpose computer, a processor, a processor core, or fixed function circuitry, as a program, software, or firmware, stored in a non-transitory computer readable medium or in another medium, executable by a general purpose computer, a processor, or a processor core, or as a combination of software executing on a processor or fixed function circuitry. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method comprising:
obtaining statistics for operation of a device, the statistics including either or both of performance statistics and memory access statistics;
generating a plurality of visualizations of the statistics in one of an overlay mode or a scene annotation mode; and
displaying the plurality of visualizations.

2. The method of claim 1, wherein the statistics are for operations for generating a frame and displaying the plurality of visualizations includes displaying the plurality of visualizations with the frame.

3. The method of claim 2, wherein generating the plurality of visualizations is performed in the overlay mode and comprises generating an overlay based on the statistics and displaying the overlay over the frame.

4. The method of claim 2, wherein generating the plurality of visualizations is performed in the scene annotation mode and comprises generating annotations based on the statistics.

5. The method of claim 4, wherein generating the annotations comprises performing a two-pass technique in which the statistics are recorded in a first pass and the annotations are generated in a second pass based on the statistics recorded in the first pass.

6. The method of claim 5, wherein generating the annotations includes generating annotations using a modified shader program in the second pass, wherein the modified shader program is a modified version of a shader program used to generate the frame in the first pass.

7. The method of claim 6, wherein the shader program comprises a pixel shader program or a compute kernel.

8. The method of claim 7, wherein the modified shader program is configured to generate a modification to a pixel generated by the shader program in the first pass, wherein the modification is for one of color, depth, luminance, or transparency.

9. The method of claim 7, wherein the shader program comprises a modified compute kernel configured to generate a modification to a generated output value in the first pass, wherein the modification is for one of color, depth, luminance, or transparency.

10. The method of claim 1, wherein:
the performance statistics are stored in a plurality of performance log entries;
the memory access statistics are stored in a plurality of memory access log entries; and
the plurality of performance log entries include a plurality of pointers to a plurality of memory access log entries.

11. A device comprising:
a processing device; and
a memory visualization generator configured to:
obtain statistics for operation of the processing device device, the statistics including either or both of performance statistics and memory access statistics;
generating a plurality of visualizations of the statistics in one of an overlay mode or a scene annotation mode; and
displaying the plurality of visualizations.

12. The device of claim 10, wherein the statistics are for operations for generating a frame and displaying the plurality of visualizations includes displaying the plurality of visualizations with the frame.

13. The device of claim 12, wherein generating the plurality of visualizations is performed in the overlay mode and comprises generating an overlay based on the statistics and displaying the overlay over the frame.

14. The device of claim 12, wherein generating the plurality of visualizations is performed in the scene annotation mode and comprises generating annotations based on the statistics.

15. The device of claim 14, wherein generating the annotations comprises performing a two-pass technique in which the statistics are recorded in a first pass and the annotations are generated in a second pass based on the statistics recorded in the first pass.

16. The device of claim 15, wherein generating the annotations includes generating annotations using a modified shader program in the second pass, wherein the modified shader program is a modified version of a shader program used to generate the frame in the first pass.

17. The device of claim 16, wherein the shader program comprises a pixel shader program or a compute kernel.

18. The device of claim 17, wherein the modified shader program is configured to generate a modification to a pixel generated by the shader program in the first pass, wherein the modification is for one of color, depth, luminance, or transparency.

19. The device of claim 17, wherein the shader program comprises a modified compute kernel configured to generate a modification to a generated output value in the first pass, wherein the modification is for one of color, depth, luminance, or transparency.

20. The device of claim 10, wherein:
the performance statistics are stored in a plurality of performance log entries;
the memory access statistics are stored in a plurality of memory access log entries; and
the plurality of performance log entries include a plurality of pointers to a plurality of memory access log entries.
